(19) United States
(12) Patent Application Publication
(10) Pub. No.: US 2024/0052841 A1
(43) Pub. Date: Feb. 15, 2024

(54) METHOD FOR CONTROLLING ELECTRIC OIL PUMP, AND DEVICE THEREFOR

(71) Applicant: LG INNOTEK CO., LTD., Seoul (KR)

(72) Inventors: Won Kyu KIM, Seoul (KR); Young Woo NOH, Seoul (KR); Jang Hoon KIM, Seoul (KR)

(21) Appl. No.: 18/259,137

(22) PCT Filed: Dec. 9, 2021
(86) PCT No.: PCT/KR2021/018695

§ 371 Date: Jun. 23, 2023

(30) Foreign Application Priority Data
Dec. 24, 2020 (KR) 10-2020-0183630

(51) Int. Cl. F04D 15/00; F04D 15/02

(52) U.S. Cl. CPC F04D 15/0066; F04D 15/0254

(57) ABSTRACT

A electric oil pump control method according to an embodiment of the present invention comprises the steps of: receiving a speed command from a transmission control unit; controlling the electric oil pump through speed control according to the speed command; determining whether the power of the electric oil pump is equal to or less than a reference power; controlling the electric oil pump through static power control, when the power of the electric oil pump is equal to or less than the reference power; determining whether a difference between the speed of the speed command and the speed of the electric oil pump is within a first range; and controlling the electric oil pump through the speed control when a difference between the speed of the speed command and the speed of the electric oil pump is within a first range.

### TECHNICAL FIELD

The present invention relates to a method and an apparatus for controlling an electric oil pump, and more particularly, to an electric oil pump control method using speed control and static force control, and an electric oil pump control apparatus.

### BACKGROUND ART

The P, N, R, and D gear shifting of a vehicle is performed by applying an electric oil pump (EOP) or a shift-by-wire system (SBW). In the case of using an electric oil pump, a problem in which the pressure of the oil supplied to the transmission is rapidly reduced may occur when gears of a vehicle is shifting, so there is a need for a technology for solving a problem in which the pressure of oil supplied to the transmission is rapidly reduced during shifting gears of a vehicle.

### DETAILED DESCRIPTION OF THE INVENTION

### Technical Subject

The technical problem to be solved by the present invention is to provide an electric oil pump control method and an electric oil pump control apparatus for controlling the electric oil pump using speed control and constant power control.

### Technical Solution

In order to solve the above technical problem, an electric oil pump control method according to an embodiment of the present invention comprises the steps of: receiving a speed command from a transmission control unit; controlling the electric oil pump through speed control according to the speed command; determining whether the power of the electric oil pump is equal to or less than a reference power; controlling the electric oil pump through constant power control, when the power of the electric oil pump is equal to or less than the reference power; determining whether a difference between the speed of the speed command and the speed of the electric oil pump is within a first range; and controlling the electric oil pump through the speed control when a difference between the speed of the speed command and the speed of the electric oil pump is within a first range.

In addition, when the difference between the speed of the speed command and the speed of the electric oil pump is greater than a first range, the electric oil pump may be controlled through the constant power control until a difference between the speed of the speed command and the speed of the electric oil pump becomes within a first range.

In addition, the speed control may control the speed of the electric oil pump to be the speed of the speed command, and the constant power control may control the power of the electric oil pump to become the reference power.

In addition, before the step of determining whether the power of the electric oil pump is less than the reference power, it includes the steps of: determining whether the speed command is a stop command of the electric oil pump; determining whether a difference between the speed of the electric oil pump and the stop speed of the electric oil pump is within a second range when the speed command is a stop command of the electric oil pump; and stopping the electric oil pump when the difference between the speed of the electric oil pump and the stop speed of the electric oil pump is within the second range, wherein the step of determining whether the power of the electric oil pump is less than or equal to a reference power may be performed when the speed command is not the stop command of the electric oil pump.

In addition, when the difference between the speed of the electric oil pump and the stop speed of the electric oil pump is greater than a second range, the electric oil pump can be controlled through the speed control until the difference between the speed of the electric oil pump and the stop speed of the electric oil pump becomes within a second range.

In order to solve the above technical problem, an electric oil pump control apparatus according to an embodiment of the present invention includes: a speed control unit for controlling the electric oil pump through speed control according to a speed command received from the transmission control unit; and the constant power control unit for controlling the electric oil pump through constant power control when the power of the electric oil pump is less than the reference power.

In addition, the speed control unit controls the electric oil pump when receiving a speed command from the transmission control unit, the constant power control unit controls the electric oil pump until the difference between the speed of the speed command and the speed of the electric oil pump is within a first range when the power of the electric oil pump is less than or equal to the reference power, and the speed control unit may control the electric oil pump when the difference between the speed of the speed command and the speed of the electric oil pump is within a first range.

In addition, the speed control unit controls the speed of the electric oil pump to be the speed of the speed command, and the constant power control unit may control the power of the electric oil pump to be the reference power.

In addition, the constant power control unit may not perform constant power control when the difference between the speed of the speed command and the stop speed of the electric oil pump is within a second range.

In addition, the constant power control unit may perform constant power control using PID control.

In addition, it may include: a flux-torque unit for outputting a current command according to a signal from the speed control unit or the constant power control unit; a current control unit for controlling the current of the electric oil pump according to the current command of the flux torque unit; and an outer loop unit for outputting a magnetic flux command to the flux torque unit using the voltage of the current control unit, the speed of the electric oil pump motor, and the input voltage.

In addition, the flux torque unit calculates the power of the current electric oil pump according to the current command being outputted, and the constant power control unit may receive the power of the current electric oil pump and determine whether it is less than or equal to a reference power.

### Advantageous Effects

According to embodiments of the present invention, it is possible to respond to a sudden decrease in oil pressure during shifting by controlling power by using power instead of current.

### BRIEF DESCRIPTION OF DRAWINGS

FIG. 1 is a block diagram of an electric oil pump control apparatus according to an embodiment of the present invention.

FIGS. 2 and 3 are block diagrams of an electric oil pump control apparatus according to an embodiment of the present invention.

FIGS. 4 and 5 are drawings for explaining the operation of an electric oil pump control apparatus according to an embodiment of the present invention.

FIG. 6 is a flowchart of an electric oil pump control method according to an embodiment of the present invention.

FIGS. 7 to 9 are flowcharts of an electric oil pump control method according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

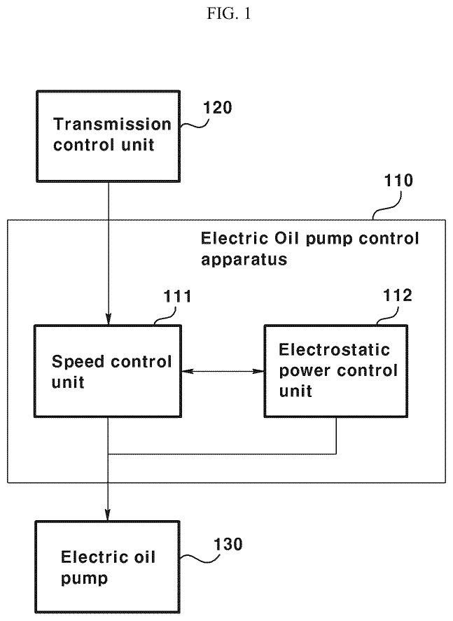

FIG. 1 is a block diagram of an electric oil pump control apparatus according to an embodiment of the present invention.

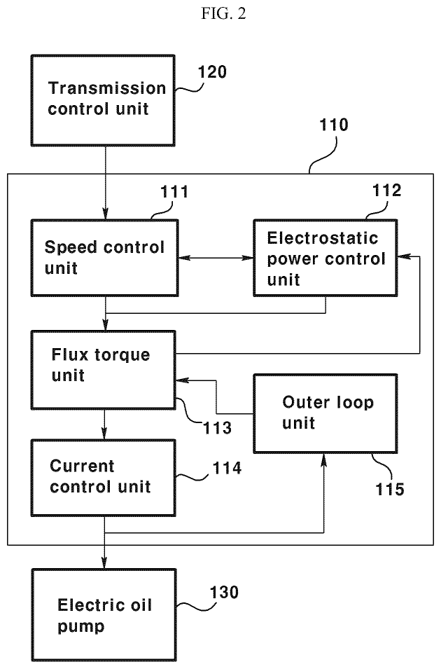

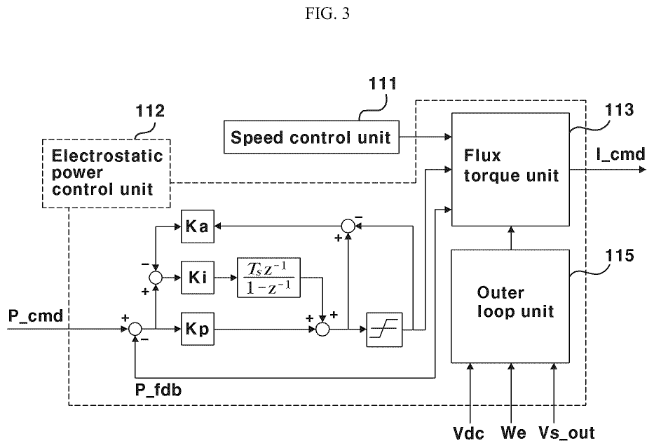

FIGS. 2 and 3 are block diagrams of an electric oil pump control apparatus according to an embodiment of the present invention.

An electric oil pump control apparatus 110 according to an embodiment of the present invention is configured with a speed control unit 111 and an constant power control unit 112, and may include a flux torque unit 113, a current control unit 114, or an outer loop unit 115.

The speed control unit 111 controls the electric oil pump 130 through speed control according to a speed command received from the transmission control unit 120.

More specifically, the speed control unit 111 controls the speed of the electric oil pump 130 to be the speed of the speed command received from the transmission control unit 120. The transmission control unit 120 may be a transmission control unit (TCU), and in order to supply oil to a transmission, a speed command for controlling the speed of a motor driving the electric oil pump 130 may be transmitted to the electric oil pump control apparatus 110. Here, the speed command may be a signal or data including information on the speed of the motor of the electric oil pump 130, that is, the rotation speed (rpm). Hereinafter, the speed of the motor will be expressed as the speed of the electric oil pump 130. The speed control unit 111 receives the speed command and controls the electric oil pump 130 so that the speed of the electric oil pump 130 becomes the speed of the speed command.

The speed control unit 111 may perform a control to increase the speed of the electric oil pump 130 when the difference between the speed of the electric oil pump 130 and the speed of the speed command is out of a reference range. The speed control unit 111 may control the speed of the electric oil pump 130 by varying the torque or current of the electric oil pump 130.

The constant power control unit 112 controls the electric oil pump 130 through constant power control when the power of the electric oil pump 130 is equal to or less than a reference power.

More specifically, in the process of controlling the electric oil pump 130, the constant power control unit 112 controls the electric oil pump 130 so that the electric power of the electric oil pump 130 becomes the reference power when the power of the electric oil pump 130 is equal to or less than the reference power. That is, the constant power control unit 112 controls the electric oil pump 130 so that the electric power of the electric oil pump 130 maintains the reference power. The constant power control unit 112 detects whether the power of the electric oil pump 130 is equal to or less than the reference power, and controls the electric oil pump 130 through constant power control when the power of the electric oil pump 130 becomes equal to or less than the reference power. Here, the reference power may be set to power at which the electric oil pump 130 operates at a speed according to the speed command during shift. The reference power can be set differently according to the speed command or set by a user. In contrast to speed control in which speed is controlled correspondingly in proportion to a decrease in torque or current, constant power control controls to maintain a reference power based on the reference power, and accurate control is possible because an accurate reference can be used.

Upon receiving a speed command from the transmission control unit 120, first, the speed control unit 111 controls the electric oil pump 130 through speed control. When the power of the electric oil pump 130 is equal to or less than the reference power while the speed control unit 111 performs speed control, the constant power control unit 112 controls the electric oil pump 130 until the difference between the speed of the speed command and the speed of the electric oil pump 130 falls within a first range. That is, when the power of the electric oil pump 130 becomes equal to or less than the reference power during speed control, it performs constant power control, not speed control. When the difference between the speed of the speed command and the speed of the electric oil pump 130 is within a first range through constant power control, the speed control unit 111 controls the electric oil pump 130 through speed control. As described above, when a speed command is received, control of the electric oil pump 130 may be performed in the order of speed control, constant power control, and speed control.

The constant power control unit 112 may not perform constant power control when the difference between the speed of the speed command and the stop speed of the electric oil pump is within a second range. In the case of a speed command received from the transmission control unit 120 is a speed command for terminating the driving of the electric oil pump 130, not the speed command for shifting, the power of the electric oil pump 130 may not be maintained as a reference power, so when the difference between the speed of the speed command and the stop speed of the electric oil pump 130 is within a second range, only speed control may be performed without performing constant power control.

The flux-torque unit 113 may output a current command according to a signal from the speed control unit 111 or the constant power control unit 112. The flux torque unit 113 may output a current command I_cmd according to a signal from the speed control unit 111 or the constant power control unit 112 using a flux-torque map, as shown in FIG. 3. When the speed control is performed, the signal from the speed control unit 111 is used, and when constant power control is performed, the signal from the constant power control unit 112 is used. The flux-torque map represents the relationship between magnetic flux and torque, and a current command to be applied to the current control unit 114 can be derived and outputted from the magnetic flux command or torque value using the flux-torque map. Although the current command according to the magnetic flux command is derived, if it is difficult to derive the current command according to the magnetic flux command due to the current state, the maximum current command can be derived and outputted.

The current control unit 114 controls the current of the electric oil pump 130 according to a current command of the flux torque unit 113. Since the motor of the electric oil pump 130 rotates by applying a current, the rotation of the motor of the electric oil pump 130 can be controlled by controlling the current of the electric oil pump 130. When the motor of the electric oil pump 130 is a three-phase motor, the current control unit 114 may be a three-phase bridge.

The outer loop unit 115 outputs a magnetic flux command to the flux torque unit 113 using the voltage of the current control unit 114, the speed of the electric oil pump 130, and the input voltage. The outer loop, which is an outer loop control that uses an error rate, raises the target when the error rate is higher than the target according to the error rate, and lowers the target when the error rate is lower than the target. As shown in FIG. 3, it generates a magnetic flux command using input voltages Vdc of the power supply such as Vs_out a voltage being outputted from the current control unit 114 to the electric oil pump 130, an electric (angular) velocity We of the rotor of the electric oil pump motor, a battery power, and the like, and applies the generated magnetic flux command to the flux torque unit 113.

The flux torque unit 113 may calculate the power of the current electric oil pump according to the current command being outputted. The flux torque unit 113 receives the magnetic flux command from the outer loop unit 115 as shown in FIG. 3, and derives and outputs the current command according to the magnetic flux command, and at this time, it is possible to calculate the current power of the electric oil pump P_fdb from the current command being outputted.

The constant power control unit 112 may receive the current electric oil pump power and determine whether it is equal to or less than a reference power. The constant power control unit 112 controls the power of the electric oil pump 130 without a separate device or module, and as shown in FIG. 3, it is possible to receive power P_fdb of the current electric oil pump from the flux torque unit 113 and determine whether it is equal to or less than the reference power P_cmd.

When the power of the electric oil pump 130 is below a reference power, the constant power control unit 112 may control the flux torque unit 113 so that the power of the electric oil pump 130 maintains the reference power. At this time, the constant power control unit 112, as shown in FIG. 3, may perform constant power control using PID control.

The PLD control block of FIG. 3, as an example, may be implemented with various PID control or PI control blocks that allow the power of the electric oil pump 130 to maintain a reference power, or it is natural that it may be configured with a circuit or module that actually implements this.

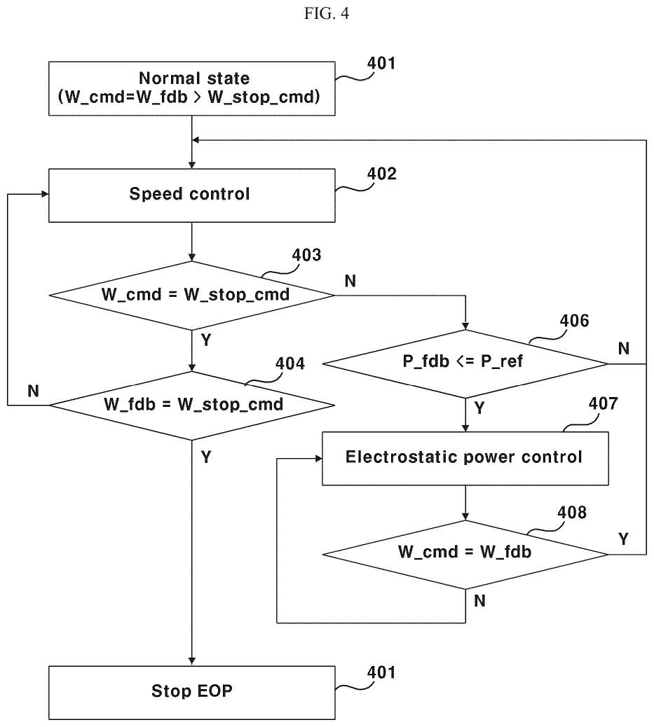

The operation of the electric oil pump control according to an embodiment of the present invention may be performed as shown in FIG. 4.

When a speed command is received from the transmission control unit 120 in a normal state in which the electric oil pump operates normally (401), the speed control of the electric oil pump is performed (402) according to the speed command. The normal state may be a case where the difference between the speed command W_cmd and the speed W-fdb of the electric oil pump is within a first range and is greater than the stop speed W_stop_cmd of the electric oil pump (W_cmd≈W_fdb>W_stop_cmd). Through the speed control described above, the speed of the electric oil pump is controlled to be the speed of the speed command.

During performing a speed control (402), when the speed command is not a stop command of the electric oil pump, it determines whether the electric oil pump power P_fdb is equal to or less than a reference power P_ref (P_fdb<=P_ref) (406), and when the electric oil pump power is equal to or less than a reference power, constant power control is performed on the electric oil pump (407). Here, the power of the electric oil pump is controlled to be the reference power through constant power control. The power P_fdb of the electric oil pump may be monitored through the flux torque unit 113 and the outer loop unit 115.

It performs constant power control, and determines whether a difference between the speed W_cmd of the speed command and the speed W_fdb of the electric oil pump is within a first range (W_cmd≈W_fdb) (408). Here, a first range is a value for determining whether the speed W_fdb of the electric oil pump is in a normal range, and may be set by a user or may be set according to specifications or input voltage of the electric oil pump 130. Or, it may be set by an error range.

When the difference between the speed of the speed command and the speed of the electric oil pump is within a first range, constant power control is terminated, and the electric oil pump is speed controlled (402). When constant power control is performed, the actual speed of the electric oil pump increases and then decreases, and when the actual speed of the electric oil pump becomes equal to the speed of the speed command, since it is no longer necessary to compensate for the decrease in oil pressure, constant power control is completed and the speed control is performed.

When the difference between the speed of the speed command and the speed of the electric oil pump is greater than a first range, constant power control is performed on the electric oil pump is until the difference between the speed of the speed command and the speed of the electric oil pump is within a first range (407).

It is determined whether the speed command W_cmd is a stop command W_stop_cmd of the electric oil pump (W_cmd=W_stop_cmd) (403), and when the speed command is a stop command of the electric oil pump, it is determined whether a difference between the speed W_fdb of the electric oil pump and the stop speed W_stop_cmd of the electric oil pump is a second range (W_fdb≈W_stop_cmd)(404). Here, a second range is a value for determining whether the speed W_fdb of the electric oil pump is within the range of the stop speed W_stop_cmd of the electric oil pump, and it may be set by a user, or may be set according to the specifications or input voltage of the electric oil pump 130. Or, it may be set by an error range.

When the difference between the speed of the electric oil pump and the stop speed of the electric oil pump is within the second range, the electric oil pump is stopped and completed (405).

When the difference between the speed of the electric oil pump and the stop speed of the electric oil pump is greater than a second range, the speed control is performed on the electric oil pump until the difference between the speed of the electric oil pump and the stop speed of the electric oil pump is within a second range (402).

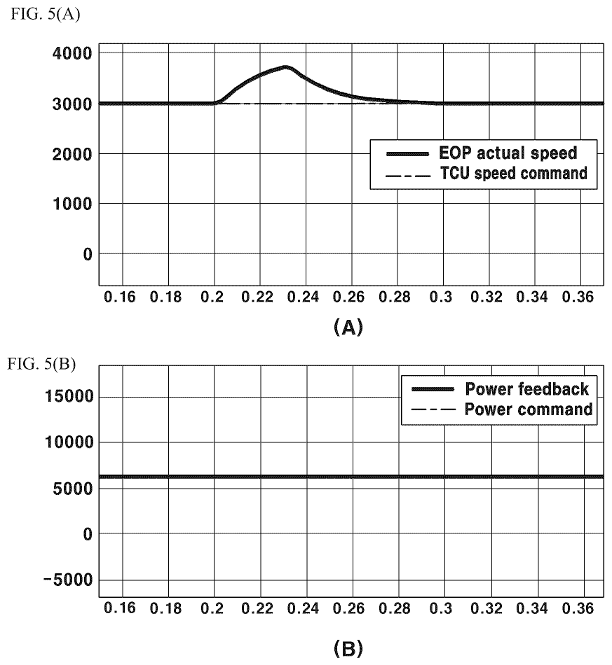

As described above, when controlling the electric oil pump using speed control and constant power control, the speed of the speed command of the transmission control unit (TCU) and the actual speed of the electric oil pump (EOP) are as shown in FIG. 5(A). When the reference power of the electric oil pump is lowered, it can be seen that the electric oil pump's electric power maintains a reference power through constant power control as shown in FIG. 5(B). When performing constant power control, it can be confirmed that the actual speed of the electric oil pump (EOP) becomes higher than the speed of the speed command and then becomes the same as the speed of the speed command, as shown in FIG. 5(A). By performing constant power control, the actual speed of the electric oil pump (EOP) increases and decreases, through which, it is possible to prevent the oil supply from being sharply reduced. By performing constant power control using the reference of a reference power along with speed control, an accurate and rapid electric oil pump control is possible.

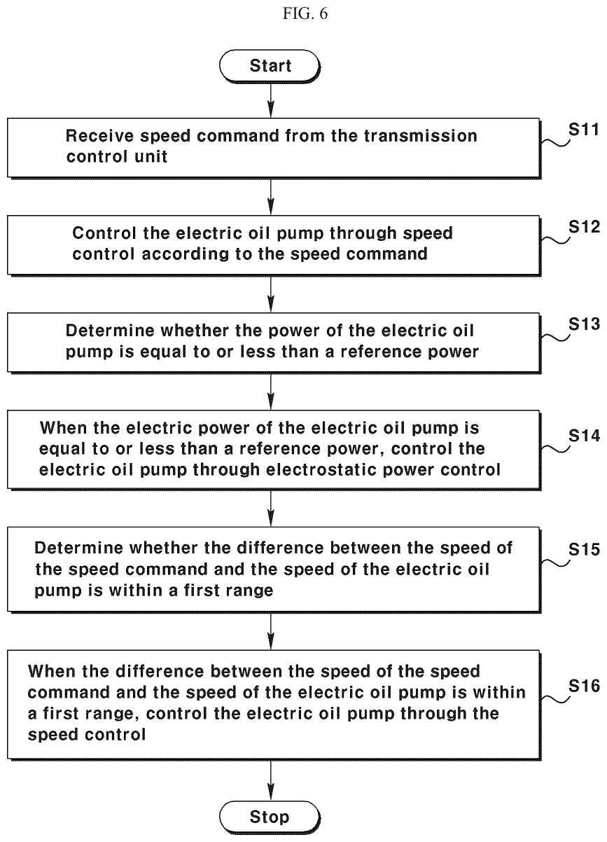

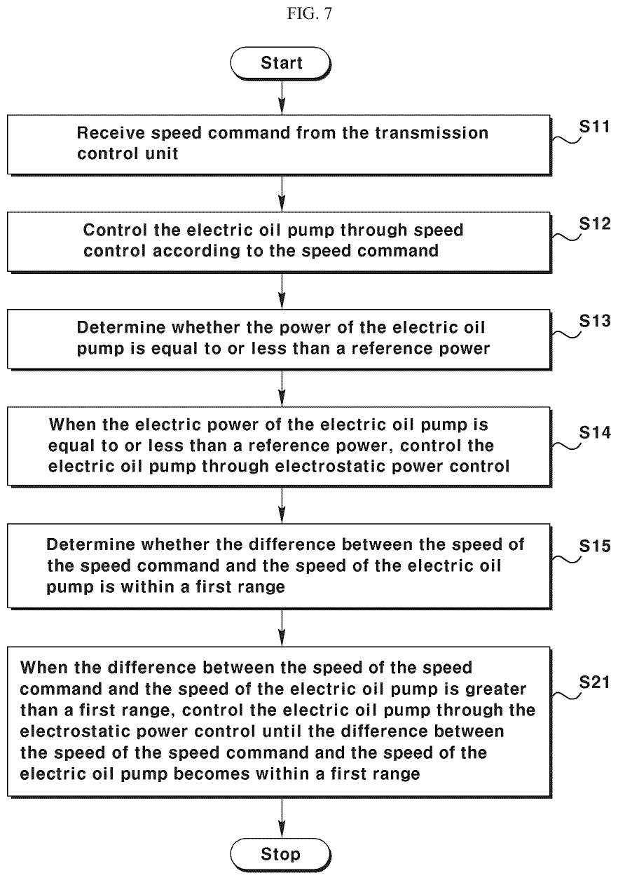

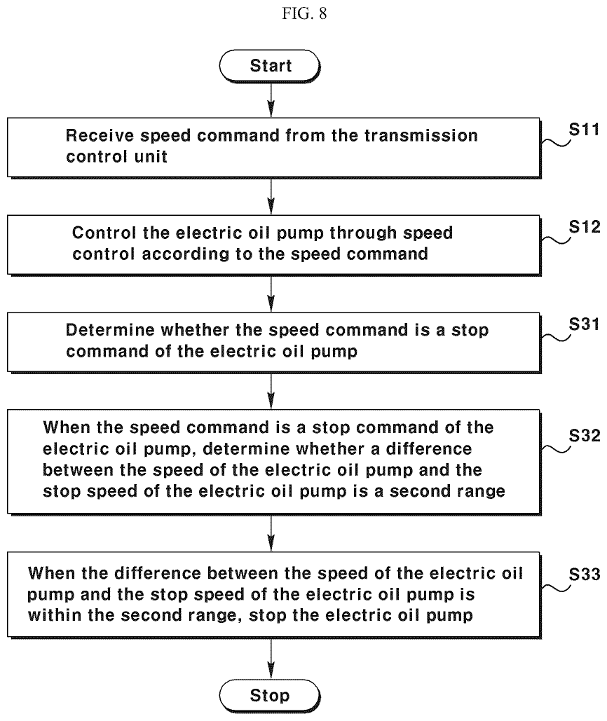

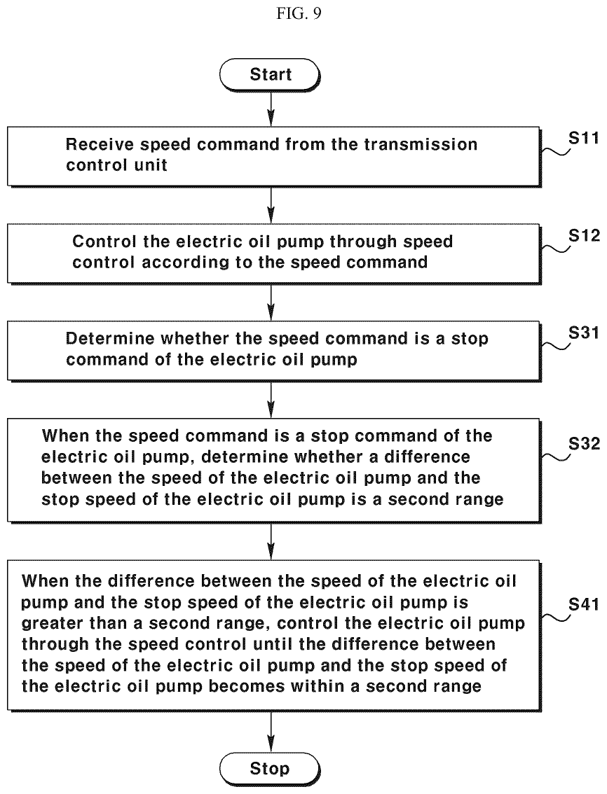

FIG. 6 is a flowchart of an electric oil pump control method according to an embodiment of the present invention, and FIGS. 7 to 9 are flowcharts of an electric oil pump control method according to an embodiment of the present invention. Since detailed description of each step of FIGS. 6 to 9 corresponds to the detailed description of the electric oil pump control apparatus of FIGS. 1 to 5, and the overlapped descriptions will be omitted below.

When a speed command is received from the transmission control unit in step S11, the electric oil pump is controlled through speed control according to the speed command in step S12. The speed control controls the speed of the electric oil pump to become the speed of the speed command. During speed control, it is determined whether the power of the electric oil pump is equal to or less than a reference power in step S13, and when the electric power of the electric oil pump is equal to or less than a reference power, the electric oil pump is controlled through constant power control in step S14. The constant power control controls the power of the electric oil pump to become the reference power.

During constant power control, in step S15, it is determined whether the difference between the speed of the speed command and the speed of the electric oil pump is within a first range, and when the difference between the speed of the speed command and the speed of the electric oil pump is within a first range, the electric oil pump is controlled through the speed control in step S16. An accurate and quick electric oil pump control is possible by performing constant power control using the reference power together with speed control being operated in sequence of speed control, constant power control, and speed control.

As a result of the determination in step S15, when the difference between the speed of the speed command and the speed of the electric oil pump is greater than a first range, the electric oil pump is controlled through the constant power control until the difference between the speed of the speed command and the speed of the electric oil pump becomes within a first range in step S21.

During speed control, before performing step S13, it is determined whether the speed command is a stop command of the electric oil pump in step S31, and when the speed command is a stop command of the electric oil pump, it is determined whether a difference between the speed of the electric oil pump and the stop speed of the electric oil pump is a second range in step S32. When the difference between the speed of the electric oil pump and the stop speed of the electric oil pump is within the second range, the electric oil pump is stopped in step S33. As a result of the determination in step S31, when the speed command is not a stop command of the electric oil pump, step S13 may be performed.

As a result of the determination in step S32, when the difference between the speed of the electric oil pump and the stop speed of the electric oil pump is greater than a second range, the electric oil pump is controlled through the speed control until the difference between the speed of the electric oil pump and the stop speed of the electric oil pump becomes within a second range in step S41.

Meanwhile, the embodiments of the present invention may be implemented as computer-readable codes on a computer-readable recording medium. The computer-readable recording medium includes all types of recording devices in which data that can be read by a computer system is stored.

As examples of computer-readable recording media there are ROM, RAM, CD-ROM, magnetic tape, floppy disk, and optical data storage devices, and in addition, they are distributed across networked computer systems in a distributed manner in which computer-readable code can be stored and executed. And functional programs, codes, and code segments for implementing the present invention can be easily inferred by programmers in the technical field to which the present invention pertains.

Those of ordinary skill in the art related to the present embodiment will understand that it can be implemented in a modified form within a scope that does not deviate from the essential characteristics of the above description. Therefore, the disclosed methods are to be considered in an illustrative rather than a restrictive sense. The scope of the present invention is indicated in the claims rather than the foregoing description, and all differences within the scope equivalent thereto should be construed as being included in the present invention.

1. An electric oil pump control method comprising the steps of:
receiving a speed command from a transmission control unit;
controlling the electric oil pump through speed control according to the speed command;
determining whether power of the electric oil pump is equal to or less than a reference power;
controlling the electric oil pump through constant power control, when the power of the electric oil pump is equal to or less than the reference power;
determining whether a difference between a speed of the speed command and a speed of the electric oil pump is within a first range; and
controlling the electric oil pump through the speed control when a difference between the speed of the speed command and the speed of the electric oil pump is within the first range.

2. The electric oil pump control method according to claim 1, wherein when the difference between the speed of the speed command and the speed of the electric oil pump is greater than the first range, the electric oil pump is controlled through the constant power control until the difference between the speed of the speed command and the speed of the electric oil pump becomes within the first range.

3. The electric oil pump control method according to claim 1, wherein the speed control controls the speed of the electric oil pump to be the speed of the speed command, and
wherein the constant power control controls the power of the electric oil pump to become the reference power.

4. The electric oil pump control method according to claim 1, prior to the step of determining whether the power of the electric oil pump is less than the reference power, comprising the steps of:
determining whether the speed command is a stop command of the electric oil pump;
determining whether a difference between the speed of the electric oil pump and a stop speed of the electric oil pump is within a second range when the speed command is the stop command of the electric oil pump; and
stopping the electric oil pump when the difference between the speed of the electric oil pump and the stop speed of the electric oil pump is within the second range,
wherein the step of determining whether the power of the electric oil pump is less than or equal to a reference power is performed when the speed command is not the stop command of the electric oil pump.

5. The electric oil pump control method according to claim 4, wherein when the difference between the speed of the electric oil pump and the stop speed of the electric oil pump is greater than the second range, the electric oil pump is controlled through the speed control until the difference between the speed of the electric oil pump and the stop speed of the electric oil pump becomes within the second range.

6. An electric oil pump control apparatus, comprising:
a speed control unit for controlling an electric oil pump through speed control according to a speed command received from a transmission control unit; and
a power control unit for controlling the electric oil pump through constant power control when power of the electric oil pump is equal to or less than a reference power.

7. The electric oil pump control apparatus according to claim 6, wherein when receiving a speed command from the transmission control unit, the speed control unit controls the electric oil pump,
wherein when the power of the electric oil pump is equal to or less than the reference power, the constant power control unit controls the electric oil pump until a difference between a speed of the speed command and a speed of the electric oil pump becomes within a first range, and
wherein when the difference between the speed of the speed command and the speed of the electric oil pump is within the first range, the speed control unit controls the electric oil pump.

8. The electric oil pump control apparatus according to claim 6, wherein the speed control unit controls a speed of the electric oil pump to be a speed of the speed command.

9. The electric oil pump control apparatus according to claim 6, wherein the constant power control unit does not perform constant power control when a difference between a speed of the speed command and a stop speed of the electric oil pump is within a second range.

10. The electric oil pump control apparatus according to claim 6, wherein the constant power control unit performs constant power control using PID control.

11. The electric oil pump control method according to claim 1, wherein the reference power is set to a power at which the electric oil pump operates at a speed according to the speed command during shift.

12. The electric oil pump control apparatus according to claim 8, wherein when the difference between the speed of the speed command and the speed of the electric oil pump is within the first range, the speed control unit controls the electric oil pump.

13. The electric oil pump control apparatus according to claim 6, wherein the constant power control unit controls the power of the electric oil pump to become the reference power.

14. The electric oil pump control apparatus according to claim 6, comprising:
a flux-torque unit configured to output a current command according to a signal from the speed control unit or the constant power control unit;
a current control unit configured to control the current of the electric oil pump according to the current command of the flux torque unit; and
an outer loop unit configured to output a magnetic flux command to the flux torque unit using the voltage of the current control unit, the speed of the electric oil pump motor, and the input voltage.

15. The electric oil pump control apparatus according to claim 14, wherein the flux torque unit outputs a current command according to the signal from the speed control unit when speed control unit operates.

16. The electric oil pump control apparatus according to claim 14, wherein the flux torque unit outputs a current command according to the signal from the constant power control unit when constant power control unit operates.

17. The electric oil pump control apparatus according to claim 14, wherein the flux torque unit calculates the power of the current electric oil pump according to the current command being outputted

18. The electric oil pump control apparatus according to claim 17, wherein the constant power control unit receives the power of the current electric oil pump and determines whether it is less than or equal to a reference power.

19. The electric oil pump control apparatus according to claim 14, wherein the current control unit comprises a three-phase bridge.

20. The electric oil pump control apparatus according to claim 7, wherein the reference power is set to a power at which the electric oil pump operates at a speed according to the speed command during shift.
